(19) United States
(12) Patent Application Publication
(10) Pub. No.: US 2026/0268941 A1
(43) Pub. Date: Sep. 10, 2026

(54) HARD DISK DRIVE COVER DAMPER WITH ENCLOSED PERIMETER

(71) Applicant: SEAGATE TECHNOLOGY LLC, Fremont, CA (US)

(72) Inventors: Patrick M. Thomas, Lyons, CO (US); Samuel Edward Severson, Longmont, CO (US); Akihiko Ohnaka, Longmont, CO (US)

(21) Appl. No.: 19/560,826

(22) Filed: Mar. 9, 2026

Related U.S. Application Data
(60) Provisional application No. 63/769,316, filed on Mar. 10, 2025.

(51) Int. Cl. G11B 33/08; G11B 33/02; G11B 33/14

(52) U.S. Cl. CPC G11B 33/08; G11B 33/027; G11B 33/1466

(57) ABSTRACT

A hard disk drive includes a base deck including an internal cavity. A process cover is coupled to the base deck to seal the internal cavity. The process cover includes a cover plate, a damper layer coupled to the cover plate, and a damping material sealed between the cover plate and the damper layer.

### RELATED APPLICATIONS

This application claims priority to U.S. Provisional Patent Application No. 63/769,316, filed March 10, 2025, incorporated by reference herein for all purposes.

### SUMMARY

In certain embodiments, a hard disk drive includes a base deck with an internal cavity. A process cover is coupled to the base deck to seal the internal cavity. The process cover includes a cover plate, a damper layer coupled to the cover plate, and a damping material sealed between the cover plate and the damper layer.

In certain embodiments, a method includes disposing a damping material at a damper section of a cover plate of a hard disk drive. The damping material is sandwiched and sealed between the cover plate and a damper layer disposed on the cover plate. The method can further include coupling an outer perimeter of the damper layer to the cover plate to form a sealed enclosure.

While multiple instances or embodiments are disclosed, still other instances of the present disclosure will become apparent to those skilled in the art from the following detailed description, which shows and describes illustrative instances of the disclosure. Accordingly, the drawings and detailed description are to be regarded as illustrative in nature and not restrictive.

### BRIEF DESCRIPTION OF THE DRAWINGS

FIG. 1 shows a cut away side view of a hard disk drive, in accordance with certain embodiments of the present disclosure.

FIG. 2A shows a top view of a process cover, in accordance with certain embodiments of the present disclosure.

FIG. 2B shows an exploded view of the process cover of FIG. 2A, in accordance with certain embodiments of the present disclosure.

FIG. 3 shows a side view of a portion of the process cover, in accordance with certain embodiments of the present disclosure.

FIG. 4 shows a block diagram of a method of making a hard disk drive, in accordance with certain embodiments of the present disclosure.

### DETAILED DESCRIPTION

Certain embodiments of the present disclosure are directed to systems, methods, and devices involving approaches that feature a cover that includes a damper section with a welded or otherwise enclosed perimeter. The enclosed perimeter can help seal a damping material such as a pressure sensitive adhesive. Because damping materials can outgas (and generate unwanted particles), sealing the damping material can reduce contamination due to outgassing. The cover can be used in hard disk drives such as the hard disk drives described herein.

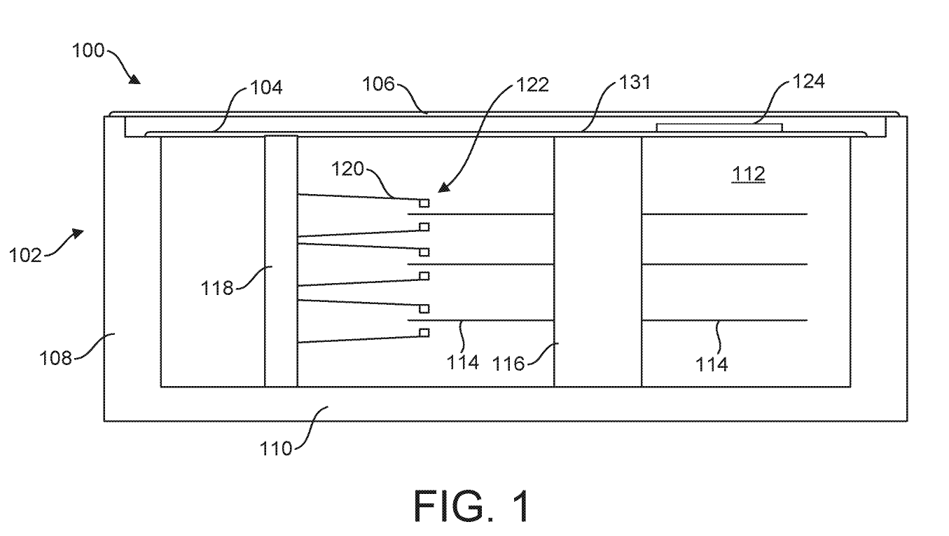

FIG. 1 shows a cut away side view of a hard disk drive 100 including a base deck 102, a process cover 104, and a final cover 106. The base deck 102 includes a sidewall 108 that, together with a bottom portion 110 of the base deck 102 and the process cover 104, create an enclosure with an internal cavity 112. The internal cavity 112 houses data storage components such as, for example, magnetic recording media 114, a spindle motor 116, an actuator pivot bearing 118, suspensions 120, read/write heads 122, etc. The spindle motor 116 and the actuator pivot bearing 118 are shown in FIG. 1 as being coupled between the process cover 104 and the bottom portion 110 of the base deck 102.

The process cover 104 can be coupled to the sidewall 108 of the base deck 102. The process cover 104 includes a damper section 124 coupled to a surface 131 of the process cover 104. The damper section 124 can be positioned between the surface 131 of the process cover 104 and the final cover 106. In certain embodiments, the damper section 124 has a surface area that is less than an overall surface area of the process cover 104. In certain embodiments, the damper section 124 has a surface area that is less than a surface area of one of the magnetic recording media 114. In some embodiments, multiple damper sections 124 can be coupled to the surface 131 of the process cover 104.

During assembly, a seal (e.g., a gasket) can be positioned between the process cover 104 and the base deck 102, and then the process cover 104 can be coupled to the base deck 102 by removable fasteners (e.g., screws). The seal is used to seal a target gas (e.g., air with nitrogen and oxygen and/or a lower-density gas like helium) within the internal cavity 112. In other embodiments, the process cover 104 is coupled to the base deck 102 without a separate seal or gasket. Once the process cover 104 is coupled to the base deck 102, a target gas may be injected into the internal cavity 112 through an aperture in the process cover 104, which is subsequently sealed. Injecting the target gas, such as a combination of air and a low-density gas like helium (e.g., 90 percent or greater helium), may involve first evacuating existing gas from the internal cavity 112 using a vacuum and then injecting the target gas from a low-density gas supply reservoir into the internal cavity 112. The aperture in the process cover 104 can be sealed via an adhesive, weld, or the like to keep the target gas within the hard disk drive 100 and, in particular, the internal cavity 112. Once the process cover 104 is sealed, the hard disk drive 100 can be subjected to a variety of processes and tests. After the hard disk drive 100 is processed and passes certain tests, the internal cavity 112 may be refilled with the target gas and then resealed. Finally, the final cover 106 can be coupled to the base deck 102 via welding (e.g., friction stir welding, laser welding).

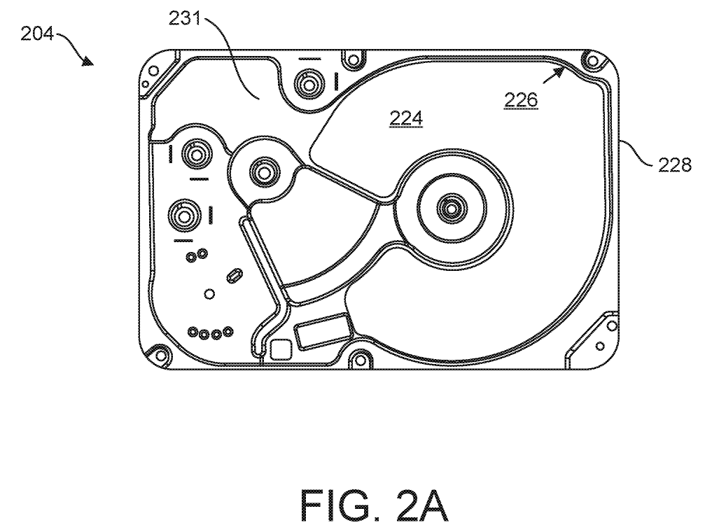

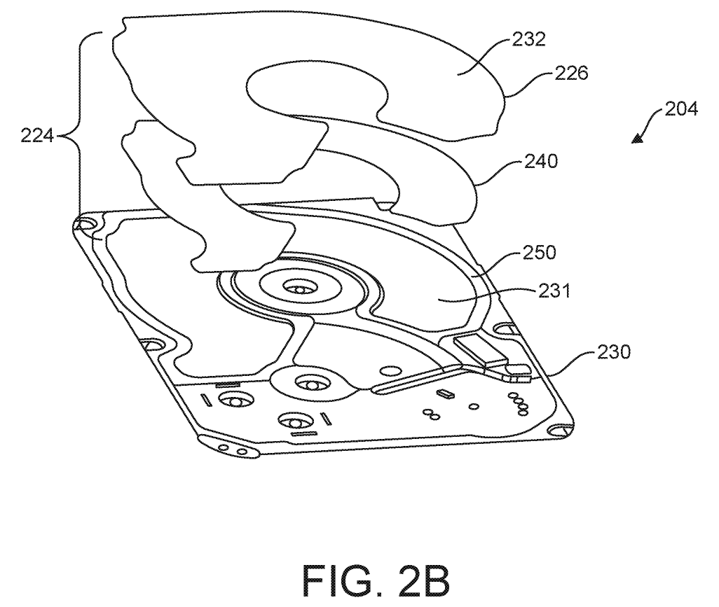

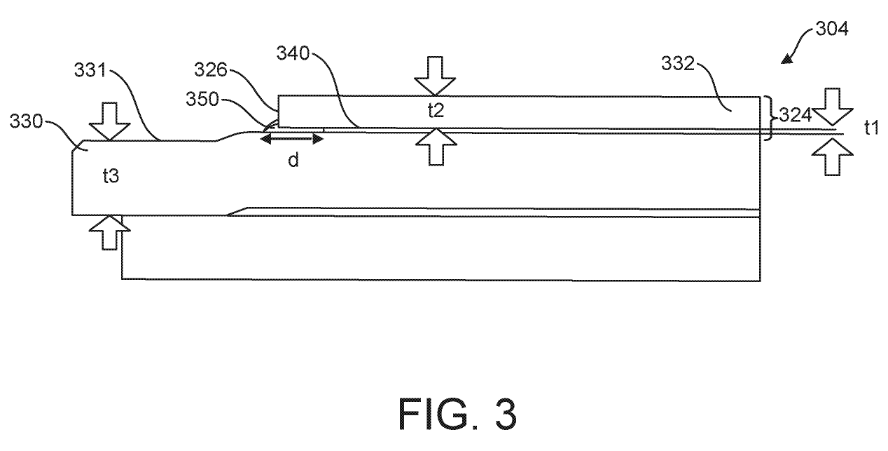

According to certain embodiments, the damper section 124 includes a damper layer and a damping material sealed between the damper layer and the surface 131 of the process cover 104. The damper section 124 can be or include a damper section 224 in FIG. 2B, and/or a damper section 324 in FIG. 3. In some embodiments, the damper layer includes an outer perimeter coupled to the surface 131 of the process cover 104 to form a sealed enclosure, and the damping material is disposed in the sealed enclosure. The damper section 124 can be positioned immediately above the magnetic recording media 114. Put another way, a vertical axis can pass through both the damper section 142 and the magnetic recording media 114 when the hard disk drive 100 is positioned such that a bottom surface of the base deck 102 extends along a horizontal plane.

FIG. 2A shows a top view of a process cover 204 including a damper section 224 coupled to a surface 231 of the process cover 204. The damper section 224 is defined by an outer perimeter 226. Portions of the outer perimeter 226 of the damper section 224 have a profile that is substantially the same shape or profile as an outer perimeter 228 of the process cover 204. Some portions of the outer perimeter 226 of the damper section 224 can have a profile that is substantially the same shape or profile as an outer perimeter of the magnetic recording media 114 (FIG. 1), which are circular shaped. As such, the outer perimeter 226 of the damper section 224 can include various straight sections and curved sections. In certain embodiments, the outer perimeter 226 of the damper section 224 is substantially C-shaped. In certain embodiments, the damper section 224 has a surface area that is less than a surface area of the process cover 204.

FIG. 2B shows an exploded view of the process cover 204 of FIG. 2A. The damper section 224 includes a damper layer 232 and a damping material 240 that is positioned between, and fully enclosed and sealed by, the damper layer 232 and a cover plate 230 of the process cover 204. The damper layer 232 and the cover plate 230 are arranged such that the outer perimeter 226 of the damper layer 232 is mechanically or metallurgically coupled to the surface 231 of the cover plate 230. This coupling forms a sealed enclosure configured to retain the damping material 240 within a defined internal volume.

The perimeter‑to‑surface coupling is achieved by an enclosure feature 250, which may include a weld, a seal, or other joining structure that extends along at least a portion of the outer perimeter 226. The enclosure feature 250 establishes a continuous or substantially continuous boundary that reduces leakage of the damping material 240 and protects the damping material 240 from environmental exposure or contamination.

Within this sealed configuration, the damping material 240 is disposed entirely inside the enclosure formed between the damper layer 232 and the cover plate 230. The damper layer 232 is dimensioned so that its footprint on the surface 231 of the cover plate 230 is slightly larger than that of the damping material 240. This dimensional relationship allows a sufficient perimeter area to be available for the enclosure feature 250 to form a seal around the damping material 240, thereby helping prevent the damping material 240 from leaking from the enclosure.

FIG. 3 shows a side view of a portion of a process cover 304, in accordance with certain embodiments of the present disclosure. The process covers of FIGS. 1, 2A, and 2B, can include the features of the process cover 304 shown in FIG. 3.

The process cover 304 includes a cover plate 330, a damper layer 332 and a damping material 340 sealed between the cover plate 330 and the damper layer 332. The damper layer 332 is coupled to a surface 331 of the cover plate 330. The damper layer 332 includes an outer perimeter 326 coupled to the cover plate 330 to form a sealed enclosure, and the damping material 340 is disposed in the sealed enclosure. In some embodiments, the sealed enclosure is enclosed by an enclosure feature 350 (e.g., a weld), which directly couples the damper layer 332 to the cover plate 330.

The damping material 340 is disposed at a damper section 324 of the process cover 304. In certain embodiments, the damper section 324 has a surface area that is less than a surface area of the process cover 304. In certain embodiments, the damper section 324 has a surface area that is less than a surface area of one of magnetic recording media. In certain embodiments, the damping material 340 (e.g., a PSA layer) and the damper layer 332 are positioned between the cover plate 330 and a final cover (e.g., the final cover 106 in FIG. 1).

In some embodiments, portions of the damper section 324 of the process cover 304 can form a multi-layer structure, which include the cover plate 330 such as a base layer, a layer of damping material 340, and the damper layer 332 as a top layer. At the outer perimeter 326, the cover plate 330 (e.g., the base layer) and the damper layer 332 are coupled to each other via the enclosure feature 350 (e.g., a weld created by laser welding). As a result, the outer perimeter 326 can include a weld that creates an enclosed space (e.g., an enclosed and sealed volume) in which the layer of damping material 340 is positioned. Other approaches for creating an enclosed space (e.g., seals, fasteners, or a combination thereof) are within the scope of the present disclosure.

In some embodiments, the damping material 340 includes a layer of adhesive such as, for example, a pressure sensitive adhesive (PSA). The damping material 340 can be sandwiched between other components (e.g., the damper layer 332 and the cover plate 330) where the damper layer 332 is used as a constrained layer damper. It is to be understood that the damping material 340 can include any suitable damping materials such as, for example, adhesives that can provide damping at the damper section 324. In some examples, the damping material 340 can include one or more viscoelastic polymer layers such as, for example, a PSA layer, an acrylic viscoelastic layer, a butyl‑rubber‑based damping layer, a polyurethane viscoelastic layer, a silicone‑based viscoelastic layer, or a combination thereof. In some examples, the damping material 340 can include a thermoplastic damping layer, a foam-based damping layer, an epoxy-based damping layer, a metal-based damping insert, a composite damping material, or a combination thereof.

The damping material 340 can be applied at the damper section 324 by any suitable processes. In some examples, the damping material 340 includes a pre-formed adhesive layer which can be applied by lamination. A release liner can be removed from the pre-formed adhesive layer before laminating the adhesive layer. In some examples, the damping material 340 can be assembled with a constraining layer (e.g., the damper layer 332) and applied at the damper section 324. In some examples, pressure may be applied across the damper section 324 using a roller, a press, a vacuum laminator, etc. In some examples, a portion of the surface 331 of the cover plate 330 at the damper section 324 can be pre-treated (e.g., cleaning, abrasion, priming, etc.) before laminating the damping material 340.

In some embodiments, the damper layer 332 is formed of a first metallic material, and the cover plate 330 is formed of a second metallic material, where each metallic material may be selected to achieve desired mechanical, thermal, and damping performance characteristics. In certain embodiments, at least one of the first metallic material and the second metallic material can include steel, such as carbon steel or stainless steel, which may be chosen for its structural rigidity, weldability, and compatibility with a constrained‑layer damping configuration. In some embodiments, the damper layer 332 and the cover plate 330 can be manufactured from the same material, for example a metallic alloy such as stainless steel, aluminum, or other suitable engineering metals, to simplify manufacturing, improve thermal expansion matching between layers, or standardize bonding and welding processes.

In some embodiments, the damper layer 332 and the cover plate 330 may be formed of different materials, chosen to achieve a targeted combination of stiffness, mass, damping effectiveness, and environmental durability. For instance, the damper layer 332 may include a high‑stiffness metal to maximize constraint effectiveness, while the cover plate 330 may include a lighter‑weight, lower-density, or more formable metal to reduce overall mass or accommodate specific geometries.

In some embodiments, the materials selected for the damper layer 332 and the cover plate 330 are chosen to be compatible with welding or joining processes, such as laser welding, resistance welding, ultrasonic welding, or brazing. Compatibility considerations may include, for example, melting temperature, thermal conductivity, absorption characteristics at the welding wavelength, and metallurgical behavior at the weld interface. Selection of materials with favorable welding characteristics helps ensure the formation of the enclosure feature 350 along the perimeter and promotes reliable sealing of the internal space that contains the damping material 340.

In some embodiments, the damping material 340 forms a layer having a thickness t1 in a range, for example, from about 0.01 mm to about 0.20 mm, from about 0.02 mm to about 0.20 mm, from about 0.02 mm to about 0.10 mm, from about 0.03 mm to about 0.08 mm, or about 0.05 mm. The damper layer 332 has a thickness t2 in a range, for example, from about 0.1 mm to about 1.0 mm, from about 0.1 mm to about 0.8 mm, from about 0.2 mm to about 0.8 mm, from about 0.2 mm to about 0.5 mm, or about 0.35 mm. The cover plate 330 has a thickness t3 in a range, for example, from about 0.1 mm to about 3.0 mm, from about 0.2 mm to about 3.0 mm, from about 0.2 mm to about 2.0 mm, from about 0.5 mm to about 1.5 mm, or about 0.8 mm. In certain embodiments, the cover plate 330 is thicker than the damper layer 332, and the damper layer 332 is thicker than the damping material 340 (e.g., a layer of adhesive).

In some embodiments, the enclosure feature 350 can be created using any suitable joining or sealing process configured to couple the outer perimeter 326 of the damper layer 332 to the surface 331 of the cover plate 330, thereby forming a sealed boundary that retains the damping material 340 within the cavity defined between the two layers. The enclosure feature 350 may extend continuously or discontinuously along the outer perimeter 326 and the surface 331.

In certain embodiments, the enclosure feature 350 is formed by joining the outer perimeter 326 of the damper layer 332 to the surface 331 of the cover plate 330 through a welding process. During such a process, localized energy is applied along the outer perimeter 326 to melt and fuse the materials of the damper layer 332 and the cover plate 330 at their interface, creating a metallurgical bond that seals the interior volume. The welding may be performed with thermal control to maintain integrity of the damping material 340 and to reduce distortion of the adjacent areas of the damper layer 332 and the cover plate 330.

In some embodiments, the welding process can be implemented using laser welding, ultrasonic welding, resistance welding, or other suitable fusion‑based or solid‑state welding techniques. For example, laser welding can provide a localized heat‑affected zone with low distortion; ultrasonic welding can generate joint formation through high‑frequency mechanical vibrations that soften the interface; and resistance welding can generate heat through electrical resistance at the joint surfaces to fuse the materials together. Any of these processes may be selected based on the material properties, joint geometry, desired bond strength, and manufacturing constraints.

In certain embodiments, the enclosure feature 350 includes a weld having a footprint d on the surface 331 of the cover plate 330. The footprint “d” can represent the visible or measurable width of the welded region, which may vary depending on the welding process parameters, the thicknesses of the adjoining materials, and the desired seal characteristics. In some embodiments, the footprint d may have a width that is comparable to the thickness t2 of the damper layer 332, providing a robust welded bond with adequate sealing performance while maintaining structural consistency along the outer perimeter 326.

In some examples, in contrast to the design of FIG. 3, when the enclosure feature 350 is not in position to form the sealed enclosure, certain components of the damping material 340 can outgas or otherwise leak into the internal cavity 112 in FIG. 1 because the damping material 340 is exposed at the outer perimeter of the damper section. The outgassed or leaked material can be detrimental to the reliability of components within the internal cavity 112 such as transducers (e.g. near field transducers).

Referring again to FIG. 3, by enclosing and sealing the damping material 340 between the cover plate 330 and the damper layer 332, the damping material 340 (e.g., a layer of adhesive) is not exposed to the rest of the sealed hard disk drive environment, and the damping material 340 (e.g., a PSA layer) can provide damping to reduce vibration.

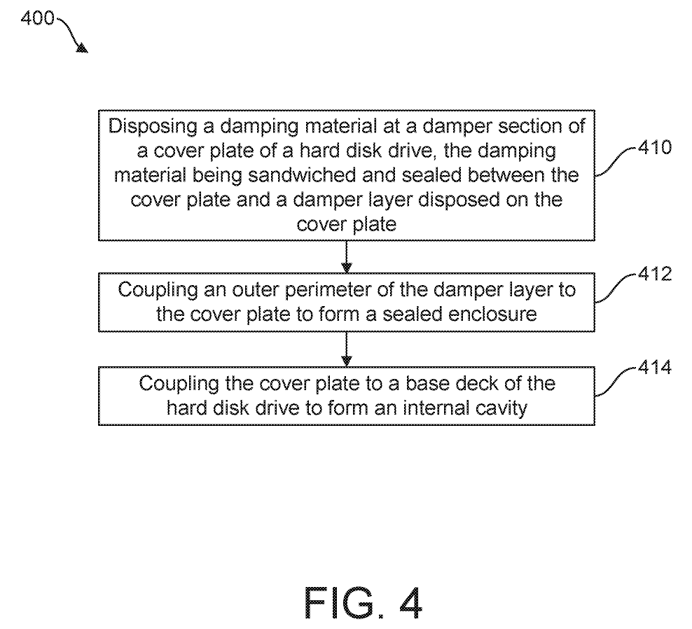

FIG. 4 shows a block diagram of a method 400 of making a hard disk drive. The method 400 includes disposing a damping material at a damper section of a cover plate of a hard disk drive (block 410). The damping material is sandwiched and sealed between the cover plate and a damper layer disposed on the cover plate. In some embodiments, the damping material includes a layer of adhesive that is applied at the damper section The method 400 further includes coupling an outer perimeter of the damper layer to the cover plate to form a sealed enclosure (block 412). In some embodiments, the outer perimeter of the damper layer is coupled to the cover plate by welding to enclose the damping material in the sealed enclosure. The method 400 further includes coupling the cover plate to a base deck of the hard disk drive to form an internal cavity (block 414). In some embodiments, the internal cavity is filled with a target gas.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features.

What is claimed is:

1. A hard disk drive comprising:
a base deck including an internal cavity; and
a process cover coupled to the base deck to seal the internal cavity,
wherein the process cover includes:
a cover plate;
a damper layer coupled to the cover plate; and
a damping material sealed between the cover plate and the damper layer.

2. The hard disk drive of claim 1, wherein the damper layer includes an outer perimeter coupled to the cover plate to form a sealed enclosure.

3. The hard disk drive of claim 2, wherein the damping material is disposed in the sealed enclosure.

4. The hard disk drive of claim 2, wherein the sealed enclosure is enclosed by a weld.

5. The hard disk drive of claim 4, wherein the weld directly couples the damper layer to the cover plate.

6. The hard disk drive of claim 1, wherein:
the damper layer comprises a first metal; and
the cover plate comprises a second metal.

7. The hard disk drive of claim 6, wherein at least one of the first metal and the second metal comprises steel.

8. The hard disk drive of claim 1, wherein the damping material comprises a layer of adhesive.

9. The hard disk drive of claim 8, wherein the layer of adhesive comprises a pressure sensitive adhesive (PSA).

10. The hard disk drive of claim 1, wherein the base deck includes a sidewall and a bottom portion to form the internal cavity of the base deck.

11. The hard disk drive of claim 10, wherein the process cover is coupled to the sidewall of the base deck.

12. The hard disk drive of claim 10, further comprising one or more data storage components disposed in the internal cavity between the process cover and the bottom portion of the base deck.

13. The hard disk drive of claim 1, wherein the damper layer is interposed between the cover plate and a final cover.

14. The hard disk drive of claim 1, further comprising a target gas within the internal cavity.

15. The hard disk drive of claim 1, wherein the damping material has a thickness in range from about 0.01 mm to about 0.20 mm.

16. A method comprising:
disposing a damping material at a damper section of a cover plate of a hard disk drive, the damping material being sandwiched and sealed between the cover plate and a damper layer disposed on the cover plate; and
coupling an outer perimeter of the damper layer to the cover plate to form a sealed enclosure.

17. The method of claim 16, wherein the outer perimeter of the damper layer is coupled to the cover plate by welding to enclose the damping material in the sealed enclosure.

18. The method of claim 16, wherein the disposing a damping material at a damper section of a cover plate comprises applying a layer of adhesive at the damper section.

19. The method of claim 16, further comprising coupling the cover plate to a base deck of the hard disk drive to form an internal cavity.

20. The method of claim 19, further comprising filling the internal cavity with a target gas.
